(19) United States
(12) Patent Application Publication
(10) Pub. No.: US 2023/0134348 A1
(43) Pub. Date: May 4, 2023

(54) TRAINING CLASSIFICATION MACHINE LEARNING MODELS WITH IMBALANCED TRAINING SETS

(71) Applicant: Optum, Inc., Minnetonka, MN (US)

(72) Inventors: Kartik Chaudhary, Bangalore (IN); Ankit Varshney, Delhi (IN); Rajat Gupta, Ghaziabad (IN); Snigdha Sree Borra, Hyderabad (IN); Yogesh K. Dagar, New Delhi (IN)

(21) Appl. No.: 17/453,265

(22) Filed: Nov. 2, 2021

(51) Int. Cl. G06N 5/02; G06N 5/04

(52) U.S. Cl. CPC G06N 5/022; G06N 5/04

(57) ABSTRACT

Various embodiments of the present invention provide methods, apparatus, systems, computing devices, computing entities, and/or the like for performing predictive data analysis operations. For example, certain embodiments of the present invention utilize systems, methods, and computer program products that perform predictive data analysis operations by machine learning models that are trained using one or more filtered training entries that are selected from a plurality of candidate training entries in accordance with one or more optimal imbalance adjustment conditions, where the one or more optimal imbalance adjustment conditions that are selected from a plurality of candidate imbalance adjustment conditions in a manner that is configured to maximize a cumulative target score for the one or more optimal imbalance adjustment conditions while a cumulative non-target score for the one or more optimal imbalance adjustment conditions satisfies an upper cumulative non-target score threshold.

### BACKGROUND

Various embodiments of the present invention address technical challenges related to performing predictive data analysis operations and address the efficiency and reliability shortcomings of existing predictive data analysis solutions.

### BRIEF SUMMARY

In general, embodiments of the present invention provide methods, apparatus, systems, computing devices, computing entities, and/or the like for performing predictive data analysis operations. For example, certain embodiments of the present invention utilize systems, methods, and computer program products that perform predictive data analysis operations by machine learning models that are trained using one or more filtered training entries that are selected from a plurality of candidate training entries in accordance with one or more optimal imbalance adjustment conditions, where the one or more optimal imbalance adjustment conditions that are selected from a plurality of candidate imbalance adjustment conditions in a manner that is configured to maximize a cumulative target score for the one or more optimal imbalance adjustment conditions while a cumulative non-target score for the one or more optimal imbalance adjustment conditions satisfies an upper cumulative non-target score threshold.

In accordance with one aspect, a method is provided. In one embodiment, the method comprises: determining, using a machine learning model, and based at least in part on the predictive input, the predictive output, wherein: (i) the machine learning model is trained using one or more filtered training entries that are selected from a plurality of candidate training entries in accordance with one or more optimal imbalance adjustment conditions, and (ii) the one or more optimal imbalance adjustment conditions that are selected from a plurality of candidate imbalance adjustment conditions in a manner that is configured to maximize a cumulative target score for the one or more optimal imbalance adjustment conditions while a cumulative non-target score for the one or more optimal imbalance adjustment conditions satisfies an upper cumulative non-target score threshold; and performing one or more prediction-based actions based at least in part on the predictive output.

In accordance with another aspect, a computer program product is provided. The computer program product may comprise at least one computer-readable storage medium having computer-readable program code portions stored therein, the computer-readable program code portions comprising executable portions configured to: determine, using a particular machine learning model, and based at least in part on the predictive input, the predictive output, wherein: (i) the machine learning model is trained using one or more filtered training entries that are selected from a plurality of candidate training entries in accordance with one or more optimal imbalance adjustment conditions, and (ii) the one or more optimal imbalance adjustment conditions that are selected from a plurality of candidate imbalance adjustment conditions in a manner that is configured to maximize a cumulative target score for the one or more optimal imbalance adjustment conditions while a cumulative non-target score for the one or more optimal imbalance adjustment conditions satisfies an upper cumulative non-target score threshold; and perform one or more prediction-based actions based at least in part on the predictive output.

In accordance with yet another aspect, an apparatus comprising at least one processor and at least one memory including computer program code is provided. In one embodiment, the at least one memory and the computer program code may be configured to, with the processor, cause the apparatus to: determine, using a machine learning model, and based at least in part on the predictive input, the predictive output, wherein: (i) the machine learning model is trained using one or more filtered training entries that are selected from a plurality of candidate training entries in accordance with one or more optimal imbalance adjustment conditions, and (ii) the one or more optimal imbalance adjustment conditions that are selected from a plurality of candidate imbalance adjustment conditions in a manner that is configured to maximize a cumulative target score for the one or more optimal imbalance adjustment conditions while a cumulative non-target score for the one or more optimal imbalance adjustment conditions satisfies an upper cumulative non-target score threshold; and perform one or more prediction-based actions based at least in part on the predictive output.

### BRIEF DESCRIPTION OF THE DRAWINGS

Having thus described the invention in general terms, reference will now be made to the accompanying drawings, which are not necessarily drawn to scale, and wherein:

FIG. 1 provides an exemplary overview of an architecture that can be used to practice embodiments of the present invention.

FIG. 2 provides an example predictive data analysis computing entity in accordance with some embodiments discussed herein.

FIG. 3 provides an example client computing entity in accordance with some embodiments discussed herein.

FIG. 4 is a flowchart diagram of an example process for training a machine learning model using a set of filtered training entries that are selected from a set of candidate training entries in accordance with one or more optimal imbalance adjustment conditions in accordance with some embodiments discussed herein.

FIG. 5 is a flowchart diagram of an example process for generating a set of optimal imbalance adjustment conditions in accordance with some embodiments discussed herein.

FIG. 6 provides an operational example of a machine learning model that is configured to generate a primary event likelihood and a dependent event likelihood in accordance with some embodiments discussed herein.

FIG. 7 provides an operational example of a machine learning component that comprises an identifier machine learning node and a differentiator machine learning node in accordance with some embodiments discussed herein.

FIG. 8 provides an operational example of a prediction output user interface in accordance with some embodiments discussed herein.

### DETAILED DESCRIPTION

Various embodiments of the present invention now will be described more fully hereinafter with reference to the accompanying drawings, in which some, but not all, embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present invention are described with reference to predictive data analysis, one of ordinary skill in the art will recognize that the disclosed concepts can be used to perform other types of data analysis tasks.

### I. Overview and Technical Improvements

Various embodiments of the present invention introduce techniques for training classification machine learning models with imbalanced training sets. An imbalanced training set is a training set that includes either too many or too few training entries that correspond to a target class (e.g., a target class that corresponds to overturning of a claim adjudication determination after appeal of the claim adjudication determination and due to organizational error in the claim adjudication determination). When a training set includes a suboptimal share of training entries that correspond to a target class, the resulting trained machine learning models may be ineffective for detecting instances of the target class, because the machine learning models have learned that instances of the target class are rare, thus leading to under-detection of the noted class. As a result, predictive data analysis systems that use classification machine learning models that are trained with imbalanced training sets often need to perform a large number of training iterations with large training sets, thus leading to expensive use of computational resources for training of machine learning models with large amounts of imbalanced training sets.

Accordingly, various embodiments of the present invention address technical challenges associated with efficiency of training machine learning models given imbalanced training sets by introducing techniques for effective training of machine learning models even given imbalanced training sets. By utilizing the techniques described in relation to various embodiments of the present invention, an imbalanced training set can nevertheless be used to train an effective and reliable machine learning model, a capability that avoids need to perform a large number of training iterations with large training sets to train suitable machine learning models, thus improving resource usage efficiency and operational throughput of predictive data analysis systems that use classification machine learning models that are trained with imbalanced training sets.

For example, various embodiments of the present invention utilize systems, methods, and computer program products that perform predictive data analysis operations by machine learning models that are trained using one or more filtered training entries that are selected from a plurality of candidate training entries in accordance with one or more optimal imbalance adjustment conditions, where the one or more optimal imbalance adjustment conditions that are selected from a plurality of candidate imbalance adjustment conditions in a manner that is configured to maximize a cumulative target score for the one or more optimal imbalance adjustment conditions while a cumulative non-target score for the one or more optimal imbalance adjustment conditions satisfies an upper cumulative non-target score threshold. The noted techniques enable various embodiments of the present invention to effectively train machine learning models even given imbalanced training sets, a capability that avoids need to perform a large number of training iterations with large training sets to train suitable machine learning models, thus improving resource usage efficiency and operational throughput of predictive data analysis systems that use classification machine learning models that are trained with imbalanced training sets.

### II. Definitions

The term “imbalance adjustment condition” may refer to a data construct that is configured to describe describes a set of predictive feature values. For example, in some embodiments, an imbalance adjustment condition may describe a combination of at least one of: (i) a particular tax identification number (TIN) value, (ii) a particular International Classification of Diagnoses (ICD) code value, and (iii) a particular health insurance policy type identifier value. In an exemplary embodiment in which an imbalance adjustment condition is associated with a particular TIN value, a particular ICD code value, and a particular health insurance policy type identifier value, then a training entry in a training class is associated with the noted imbalance adjustment condition if the training entry is associated with the particular TIN value, the particular ICD code value, and the particular health insurance policy type identifier value.

The term “optimal imbalance adjustment condition” may refer to a data construct that is configured to describe an imbalance adjustment condition that is selected to be used for filtering training entries, where the filtered training entries are selected from a set of candidate training entries in accordance with the set of optimal imbalance adjustment conditions. In some embodiments, the optimal imbalance adjustment conditions are selected from the candidate imbalance adjustment conditions in a manner that is configured to maximize a cumulative target score for the optimal imbalance adjustment conditions while a cumulative non-target score for the optimal imbalance adjustment conditions satisfies an upper cumulative non-target score threshold.

The term “target score” may refer to a data construct that is configured to describe an estimated correlation measure for a corresponding imbalance adjustment condition and a target subset of a training set (i.e., a set of candidate training entries before any filtering operations are performed) that correspond to a target class. For example, the target class may be a class of claim adjudication determinations that are overturned on appeal due to organizational error. In that example, the target score for an imbalance adjustment condition that is characterized by a particular TIN value, a particular ICD code value, and a particular health insurance policy type identifier value may describe an estimated correlation measure between: (i) whether a claim adjudication determinations for a claim is associated with the particular TIN value, the particular ICD code value, and the particular health insurance policy type identifier value, and (ii) whether the noted claim adjudication determination is recorded to have been overturned on appeal due to organizational error. In some embodiments, determining the target score for a particular candidate imbalance adjustment condition comprises: identifying a target subset of a plurality of candidate training entries that are associated with a target class; for each candidate training entry in the target subset, determining a per-target-entry condition satisfaction ratio based at least in part on: (i) a condition satisfaction indicator that describes whether the candidate training entry satisfies the particular candidate imbalance adjustment condition, and (ii) a cumulative condition satisfaction indicator for the candidate training entry that describes a count of the plurality of candidate imbalance adjustment conditions that are satisfied by the candidate training entry; and (iii) determining the target score based at least in part on each per-target-entry condition satisfaction ratio.

The term “non-target score” may refer to a data construct that is configured to describe an estimated correlation measure for a corresponding imbalance adjustment condition and a non-target subset of a training set (i.e., a set of candidate training entries before any filtering operations are performed) that do not correspond to a target class. For example, the target class may be a class of claim adjudication determinations that are overturned on appeal due to organizational error. In that example, the non-target score for an imbalance adjustment condition that is characterized by a particular TIN value, a particular ICD code value, and a particular health insurance policy type identifier value may describe an estimated correlation measure between: (i) whether a claim adjudication determination is associated with the particular TIN value, the particular ICD code value, and the particular health insurance policy type identifier value, and (ii) whether the noted claim adjudication determination is recorded not to have been overturned on appeal due to organizational error. In some embodiments, determining the non-target score for a particular candidate imbalance adjustment condition comprises: identifying a non-target subset of a plurality of candidate training entries that are associated not with a target class; for each candidate training entry in the non-target subset, determining a per-non-target-entry condition satisfaction ratio based at least in part on: (i) a condition satisfaction indicator that describes whether the candidate training entry satisfies the particular candidate imbalance adjustment condition, and (ii) a cumulative condition satisfaction indicator for the candidate training entry that describes a count of the plurality of candidate imbalance adjustment conditions that are satisfied by the candidate training entry; and (iii) determining the non-target score based at least in part on each per-non-target-entry condition satisfaction ratio.

The term “filtered training entry” may refer to a data construct that is configured to describe a training entry that satisfies requirements that are determined based at least in part on a set of optimal imbalance adjustment conditions. In some embodiments, each candidate training entry is included in the set of filtered training entries if the candidate training entry satisfies at least one of the optimal imbalance adjustment conditions. In some embodiments, each candidate training entry is included in the set of filtered training entries if the candidate training entry satisfies at least n of the optimal imbalance adjustment conditions. In some embodiments, a satisfaction score is determined for each entry-condition pair comprising a candidate training entry and an imbalance adjustment condition, then a maximal satisfaction score is determined for each candidate training entry from the satisfaction scores for entry-condition pairs that comprise the particular candidate training entry, and then m candidate training entries having highest maximal satisfaction scores are selected to be included among the noted set of filtered training entries.

The term “cumulative target score” may refer to a data construct that is configured to describe a summation measure for each target score of an imbalance adjustment condition in a corresponding subset of imbalance adjustment conditions. In some embodiments, determining the target score for a particular candidate imbalance adjustment condition comprises: identifying a target subset of a plurality of candidate training entries that are associated with a target class; for each candidate training entry in the target subset, determining a per-target-entry condition satisfaction ratio based at least in part on: (i) a condition satisfaction indicator that describes whether the candidate training entry satisfies the particular candidate imbalance adjustment condition, and (ii) a cumulative condition satisfaction indicator for the candidate training entry that describes a count of the plurality of candidate imbalance adjustment conditions that are satisfied by the candidate training entry; and (iii) determining the target score based at least in part on each per-target-entry condition satisfaction ratio. In some embodiments, once generated, the target scores of imbalance adjustment conditions are in a subset are used to determine the cumulative target score for the subset.

The term “cumulative non-target score” may refer to a data construct that is configured to describe a summation measure for each non-target score of an imbalance adjustment condition in a corresponding subset of imbalance adjustment conditions. In some embodiments, determining the non-target score for a particular candidate imbalance adjustment condition comprises: identifying a non-target subset of a plurality of candidate training entries that are not associated with a target class; for each candidate training entry in the non-target subset, determining a per-non-target-entry condition satisfaction ratio based at least in part on: (i) a condition satisfaction indicator that describes whether the candidate training entry satisfies the particular candidate imbalance adjustment condition, and (ii) a cumulative condition satisfaction indicator for the candidate training entry that describes a count of the plurality of candidate imbalance adjustment conditions that are satisfied by the candidate training entry; and (iii) determining the non-target score based at least in part on each per-non-target-entry condition satisfaction ratio. In some embodiments, once generated, the non-target scores of imbalance adjustment conditions are in a subset are used to determine the cumulative non-target score for the subset.

The term “upper cumulative non-target score threshold” may refer to a data construct that is configured to describe a maximal allowed upper limit for the cumulative non-target score of a subset of imbalance adjustment conditions if the subset is to be deemed a set of optimal imbalance adjustment conditions. In some embodiments, the optimal imbalance adjustment conditions are selected from the candidate imbalance adjustment conditions in a manner that is configured to maximize a cumulative target score for the optimal imbalance adjustment conditions while a cumulative non-target score for the optimal imbalance adjustment conditions satisfies an upper cumulative non-target score threshold.

### III. Computer Program Products, Methods, and Computing Entities

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### IV. Exemplary System Architecture

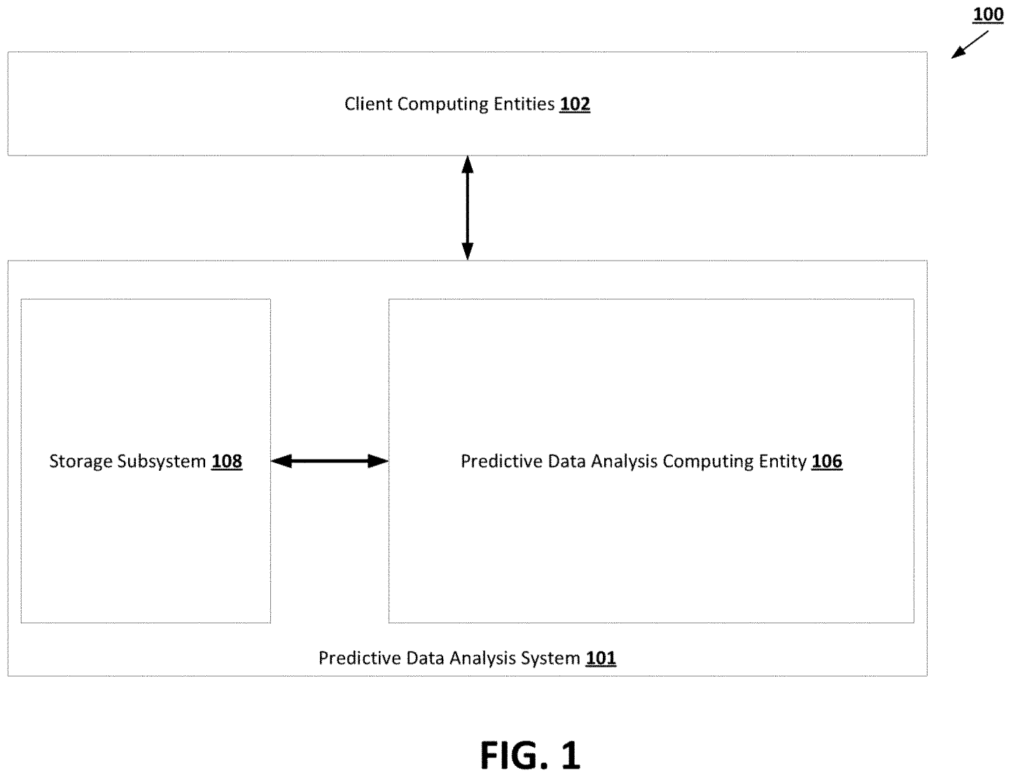

FIG. 1 is a schematic diagram of an example architecture 100 for performing predictive data analysis. The architecture 100 includes a predictive data analysis system 101 configured to receive predictive data analysis requests from client computing entities 102, process the predictive data analysis requests to generate predictions, provide the generated predictions to the client computing entities 102, and automatically perform prediction-based actions based at least in part on the generated predictions. An example of a prediction-based action that can be performed using the predictive data analysis system 101 is processing a request for determining predicted outcomes regarding whether particular claim adjudication determinations will lead to overturning due to organizational error after appeal of the noted particular claim adjudication determinations.

In some embodiments, predictive data analysis system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The predictive data analysis system 101 may include a predictive data analysis computing entity 106 and a storage subsystem 108. The predictive data analysis computing entity 106 may be configured to receive predictive data analysis requests from one or more client computing entities 102, process the predictive data analysis requests to generate predictions corresponding to the predictive data analysis requests, provide the generated predictions to the client computing entities 102, and automatically perform prediction-based actions based at least in part on the generated predictions.

The storage subsystem 108 may be configured to store input data used by the predictive data analysis computing entity 106 to perform predictive data analysis as well as model definition data used by the predictive data analysis computing entity 106 to perform various predictive data analysis tasks. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Exemplary Predictive Data Analysis Computing Entity

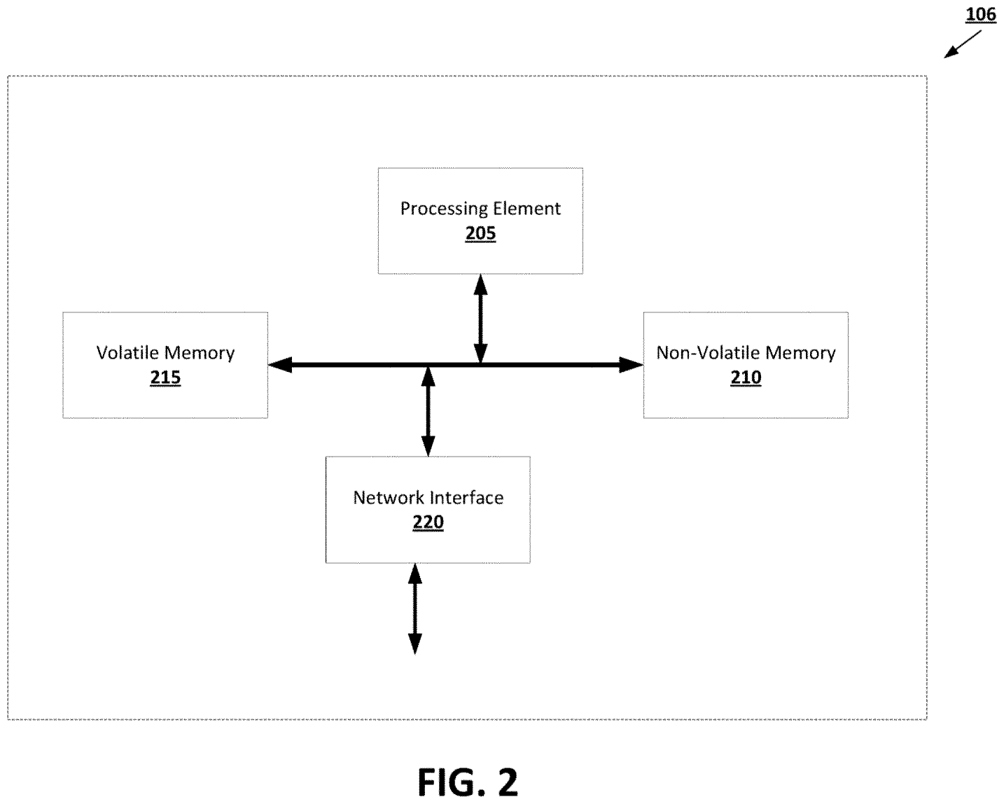

FIG. 2 provides a schematic of a predictive data analysis computing entity 106 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the predictive data analysis computing entity 106 may also include one or more communications interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the predictive data analysis computing entity 106 may include, or be in communication with, one or more processing elements 205 (also referred to as processors, processing circuitry, and/or similar terms used herein interchangeably) that communicate with other elements within the predictive data analysis computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the predictive data analysis computing entity 106 may further include, or be in communication with, non-volatile media (also referred to as non-volatile storage, memory, memory storage, memory circuitry and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity—relationship model, object model, document model, semantic model, graph model, and/or the like.

In one embodiment, the predictive data analysis computing entity 106 may further include, or be in communication with, volatile media (also referred to as volatile storage, memory, memory storage, memory circuitry and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the predictive data analysis computing entity 106 with the assistance of the processing element 205 and operating system.

As indicated, in one embodiment, the predictive data analysis computing entity 106 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the predictive data analysis computing entity 106 may include, or be in communication with, one or more input elements, such as a keyboard input, a mouse input, a touch screen/display input, motion input, movement input, audio input, pointing device input, joystick input, keypad input, and/or the like. The predictive data analysis computing entity 106 may also include, or be in communication with, one or more output elements (not shown), such as audio output, video output, screen/display output, motion output, movement output, and/or the like.

### Exemplary Client Computing Entity

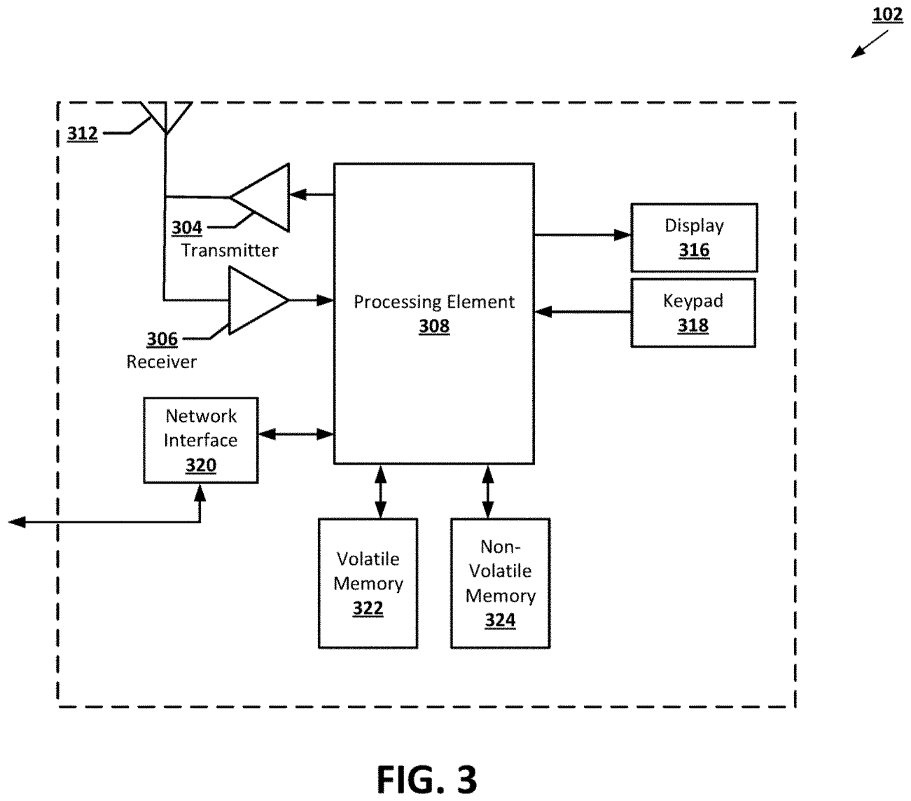

FIG. 3 provides an illustrative schematic representative of an client computing entity 102 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 can be operated by various parties. As shown in FIG. 3, the client computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the predictive data analysis computing entity 106. In a particular embodiment, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the predictive data analysis computing entity 106 via a network interface 320.

Via these communication standards and protocols, the client computing entity 102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 can also download changes, add-ons, and updates, for instance, to its firmware, software (e.g., including executable instructions, applications, program modules), and operating system.

According to one embodiment, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the client computing entity's 102 position in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The client computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the predictive data analysis computing entity 106, as described herein. The user input interface can comprise any of a number of devices or interfaces allowing the client computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The client computing entity 102 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the entity or accessible through a browser or other user interface for communicating with the predictive data analysis computing entity 106 and/or various other computing entities.

In another embodiment, the client computing entity 102 may include one or more components or functionality that are the same or similar to those of the predictive data analysis computing entity 106, as described in greater detail above. As will be recognized, these architectures and descriptions are provided for exemplary purposes only and are not limiting to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### V. Exemplary System Operations

Provided below are exemplary techniques for generating a dynamically parameterized machine learning framework and for using a trained dynamically parameterized machine learning framework to perform one or more predictive inferences. However, while various embodiments of the present invention describe the model generation operations described herein and the predictive inference operations described herein as being performed by the same single computing entity, a person of ordinary skill in the relevant technology will recognize that each of the noted sets of operations described herein can be performed by one or more computing entities that may be the same as or different from the one or more computing entities used to perform each of the other sets of operations described herein.

As described below, various embodiments of the present invention address technical challenges associated with efficiency of training machine learning models given imbalanced training sets by introducing techniques for effective training of machine learning models even given imbalanced training sets. By utilizing the techniques described in relation to various embodiments of the present invention, an imbalanced training set can nevertheless be used to train an effective and reliable machine learning model, a capability that avoids need to perform a large number of training iterations with large training sets to train suitable machine learning models, thus improving resource usage efficiency and operational throughput of predictive data analysis systems that use classification machine learning models that are trained with imbalanced training sets.

### Model Generation Operations

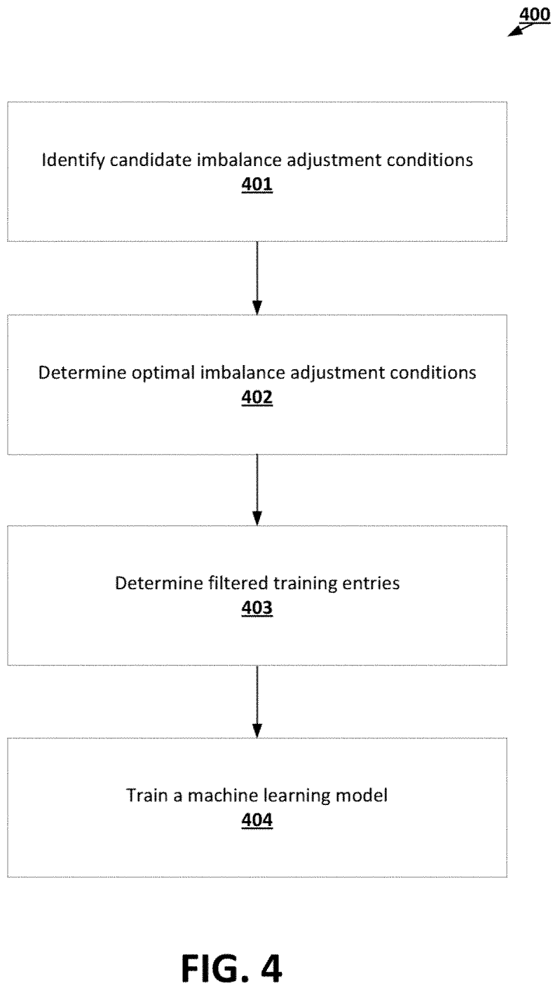

FIG. 4 is a flowchart diagram of an example process 400 for training a machine learning model using a set of filtered training entries that are selected from a set of candidate training entries in accordance with one or more optimal imbalance adjustment conditions. Via the various steps/operations of the process 400, a predictive data analysis computing entity 106 can train a machine learning model for that is configured to reliably and accurately generate a predictive output that describes a likelihood that a predictive input is associated with a target class even when the training set is imbalanced such that a suboptimal ratio of the training set is associated with the target class.

The process 400 begins at step/operation 401 when the predictive data analysis computing entity 106 identifies a set of candidate imbalance adjustment conditions. In general, each imbalance adjustment condition describes a set of predictive feature values. For example, in some embodiments, an imbalance adjustment condition may describe a combination of at least one of: (i) a particular tax identification number (TIN) value, (ii) a particular International Classification of Diagnoses (ICD) code value, and (iii) a particular health insurance policy type identifier value. In an exemplary embodiment in which an imbalance adjustment condition is associated with a particular TIN value, a particular ICD code value, and a particular health insurance policy type identifier value, then a training entry in a training class is associated with the noted imbalance adjustment condition if the training entry is associated with the particular TIN value, the particular ICD code value, and the particular health insurance policy type identifier value.

At step/operation 402, the predictive data analysis computing entity 106 determines a set of optimal imbalance adjustment conditions based at least in part on a selected subset of the set of candidate imbalance adjustment condition. An optimal imbalance adjustment condition may be an imbalance adjustment condition that is selected to be used for filtering training entries, where the filtered training entries are selected from a set of candidate training entries in accordance with the set of optimal imbalance adjustment conditions.

In some embodiments, the optimal imbalance adjustment conditions are selected from the candidate imbalance adjustment conditions in a manner that is configured to maximize a cumulative target score for the optimal imbalance adjustment conditions while a cumulative non-target score for the optimal imbalance adjustment conditions satisfies an upper cumulative non-target score threshold.

For example, in some embodiments, the optimal imbalance adjustment conditions are selected from the candidate imbalance adjustment conditions by performing operations of the below constrained optimization equation:

$${max}_{{x}_{1} , {x}_{2} , … , {x}_{C}} {{\sum }_{i = 1}}^{C} ts ( i ) * {x}_{i} \\ subject to , \\ {{\sum }_{i = 1}}^{C} nts ( i ) * {x}_{i} \leq UL \qquad \underline{Equation 1}$$

In Equation 1, xᵢ may be a binary value for an ith candidate imbalance adjustment condition that describes whether (via an xᵢ value of one) the ith candidate imbalance adjustment condition should be included among the optimal imbalance adjustment conditions or alternatively whether (via an xᵢ value of zero) the ith candidate imbalance adjustment condition should be excluded from the optimal imbalance adjustment conditions. Furthermore, in Equation 1, ts(i) is a target score for an ith candidate imbalance adjustment condition, nts(i) is a non-target score for an ith candidate imbalance adjustment condition, and UL is an upper cumulative non-target score threshold. Moreover, in Equation 1,

$${max}_{{x}_{1} , {x}_{2} , … , {x}_{C}} {{\sum }_{i = 1}}^{C} ts ( i ) * {x}_{i}$$

is a cumulative target score that is a sum of each target score for a candidate imbalance adjustment condition that is among the optimal imbalance adjustment conditions, while Σᵢ₌₁^{C}nts(i)*xᵢ is a cumulative non-target score that is a sum of each non-target score for a candidate imbalance adjustment condition that is among the optimal imbalance adjustment conditions.

In some embodiments, the above-depicted constraint optimization is solved using a Knapsack optimization routine. In some embodiments, the above-depicted constraint optimization is solved using a Knapsack optimization routine after nts and UL values are converted to nearest integers. In some embodiments, each candidate imbalance adjustment condition is associated with an integer non-target score that is determined by mapping a non-target score for the candidate imbalance adjustment condition to a nearest integer, the non-cumulative target score is determined based at least in part on each integer non-target score for a candidate imbalance adjustment condition that is among the one or more optimal imbalance adjustment conditions, and maximizing the cumulative target score while the cumulative non-target score satisfies the upper cumulative non-target score threshold comprises using a Knapsack optimization routine. Aspects of Knapsack optimization techniques are described in Wang, Combinatorial Optimization: The Knapsack Problem, available at https://towardsdatascience.com/combinatorial-optimization-the-knapsack-problem-9f7047e16028.

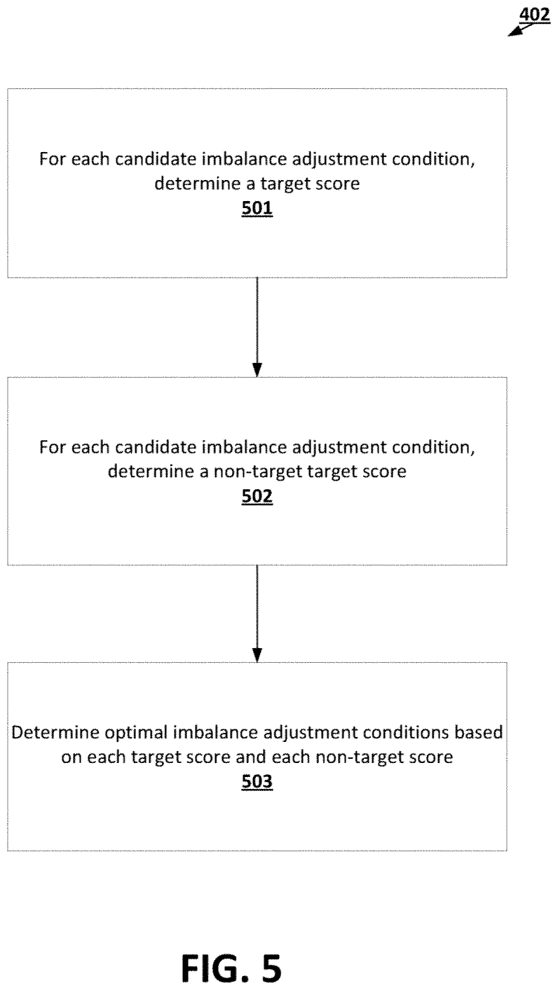

In some embodiments, step/operation 402 may be performed in accordance with the process that is depicted in FIG. 5. The process that is depicted in FIG. 5 begins at step/operation 501 when the predictive data analysis computing entity 106 determines a target score for each candidate imbalance adjustment condition. The target score for an imbalance adjustment condition may describe an estimated correlation measure for the imbalance adjustment condition and a target subset of a training set (i.e., a set of candidate training entries before any filtering operations are performed) that correspond to a target class. For example, the target class may be a class of claim adjudication determinations that are overturned on appeal due to organizational error. In that example, the target score for an imbalance adjustment condition that is characterized by a particular TIN value, a particular ICD code value, and a particular health insurance policy type identifier value may describe an estimated correlation measure between: (i) whether a claim adjudication determinations for a claim is associated with the particular TIN value, the particular ICD code value, and the particular health insurance policy type identifier value, and (ii) whether the noted claim adjudication determination is recorded to have been overturned on appeal due to organizational error.

In some embodiments, determining the target score for a particular candidate imbalance adjustment condition comprises: identifying a target subset of a plurality of candidate training entries that are associated with a target class; for each candidate training entry in the target subset, determining a per-target-entry condition satisfaction ratio based at least in part on: (i) a condition satisfaction indicator that describes whether the candidate training entry satisfies the particular candidate imbalance adjustment condition, and (ii) a cumulative condition satisfaction indicator for the candidate training entry that describes a count of the plurality of candidate imbalance adjustment conditions that are satisfied by the candidate training entry; and (iii) determining the target score based at least in part on each per-target-entry condition satisfaction ratio.

For example, the target score for an ith imbalance adjustment condition may be determined using the operations of the below equation:

$$ts ( i ) = {{\sum }_{j = 1}}^{T} \frac{TM [ i , j ]}{{{\sum }_{c = 1}}^{C} TM [ c , j ]} \qquad \underline{Equation 2}$$

In Equation 2, ts(i) is the target score for the ith imbalance adjustment condition, TM[i,j] is a condition satisfaction indicator that describes whether the jth candidate training entry corresponds to the ith imbalance adjustment condition (where j iterates over T candidate training entries in a target subset of the candidate training entries that are associated with the target class), and TM[c,j] is a condition satisfaction indicator that describes whether the jth candidate training entry in the training subset corresponds to the cth imbalance adjustment condition (where j iterates over T candidate training entries in a target subset of the candidate training entries that are associated with the target class and c iterates over C imbalance adjustment conditions). Accordingly, in Equation 2,

$$\frac{TM [ i , j ]}{{{\sum }_{c = 1}}^{C} TM [ c , j ]}$$

is a per-target-entry condition satisfaction ratio for the ith imbalance adjustment condition and the jth candidate training entry in the target subset. Moreover, in Equation 2, Σ_{c=1}^{C}TM[c,j] is the cumulative condition satisfaction indicator for the jth candidate training entry in the target subset that is determined based at least in part on each condition satisfaction indicator for the jth candidate training entry across the C imbalance adjustment conditions.

The process that is depicted in FIG. 5 begins at step/operation 502 when the predictive data analysis computing entity 106 determines a non-target score for each candidate imbalance adjustment condition. The non-target score for an imbalance adjustment condition may describe an estimated correlation measure for the imbalance adjustment condition and a non-target subset of a training set (i.e., a set of candidate training entries before any filtering operations are performed) that do not correspond to a target class. For example, the target class may be a class of claim adjudication determinations that are overturned on appeal due to organizational error. In that example, the non-target score for an imbalance adjustment condition that is characterized by a particular TIN value, a particular ICD code value, and a particular health insurance policy type identifier value may describe an estimated correlation measure between: (i) whether a claim adjudication determination is associated with the particular TIN value, the particular ICD code value, and the particular health insurance policy type identifier value, and (ii) whether the noted claim adjudication determination is recorded not to have been overturned on appeal due to organizational error.

In some embodiments, determining the non-target score for a particular candidate imbalance adjustment condition comprises: identifying a non-target subset of a plurality of candidate training entries that are associated not with a target class; for each candidate training entry in the non-target subset, determining a per-non-target-entry condition satisfaction ratio based at least in part on: (i) a condition satisfaction indicator that describes whether the candidate training entry satisfies the particular candidate imbalance adjustment condition, and (ii) a cumulative condition satisfaction indicator for the candidate training entry that describes a count of the plurality of candidate imbalance adjustment conditions that are satisfied by the candidate training entry; and (iii) determining the non-target score based at least in part on each per-non-target-entry condition satisfaction ratio.

For example, the non-target score for an ith imbalance adjustment condition may be determined using the operations of the below equation:

$$nts ( i ) = {{\sum }_{j = 1}}^{T} \frac{NTM [ i , j ]}{{{\sum }_{c = 1}}^{C} NTM [ c , j ]} \qquad \underline{Equation 3}$$

In Equation 3, nts(i) is the non-target score for the ith imbalance adjustment condition, NTM[i,j] is a condition satisfaction indicator that describes whether the jth candidate training entry in the non-target subset corresponds to the ith imbalance adjustment condition (where j iterates over T candidate training entries in a non-target subset of the candidate training entries that are not associated with the target class), and NTM[c,j] is a condition satisfaction indicator that describes whether the jth candidate training entry corresponds to the cth imbalance adjustment condition (where j iterates over T candidate training entries in a non-target subset of the candidate training entries that are not associated with the target class and c iterates over C imbalance adjustment conditions). Accordingly, in Equation 3,

$$\frac{NTM [ i , j ]}{{{\sum }_{c = 1}}^{C} NTM [ c , j ]}$$

is a per-non-target-entry condition satisfaction ratio for the ith imbalance adjustment condition and the jth candidate training entry in the non-target subset. Moreover, in Equation 2, Σ_{c=1}^{C} NTM[c,j] is the cumulative condition satisfaction indicator for the jth candidate training entry in the non-target subset that is determined based at least in part on each condition satisfaction indicator for the jth candidate training entry across the C imbalance adjustment conditions.

At step/operation 503, the predictive data analysis computing entity 106 determines the optimal imbalance adjustment conditions based at least in part on each target score for a candidate imbalance adjustment condition, each non-target score for a candidate imbalance adjustment condition, and an upper cumulative non-target score threshold, where the upper cumulative non-target score threshold may be a tuned, preconfigured, and/or trained value. As described above, in some embodiments, the optimal imbalance adjustment conditions are selected from the candidate imbalance adjustment conditions in a manner that is configured to maximize a cumulative target score for the optimal imbalance adjustment conditions while a cumulative non-target score for the optimal imbalance adjustment conditions satisfies an upper cumulative non-target score threshold.

Returning to FIG. 4, at step/operation 403, the predictive data analysis computing entity 106 determines a set of filtered training entries based at least in part on the optimal imbalance adjustment conditions. In some embodiments, each candidate training entry is included in the set of filtered training entries if the candidate training entry satisfies at least one of the optimal imbalance adjustment conditions. In some embodiments, each candidate training entry is included in the set of filtered training entries if the candidate training entry satisfies at least n of the optimal imbalance adjustment conditions. In some embodiments, a satisfaction score is determined for each entry-condition pair comprising a candidate training entry and an imbalance adjustment condition, then a maximal satisfaction score is determined for each candidate training entry from the satisfaction scores for entry-condition pairs that comprise the particular candidate training entry, and then m candidate training entries having highest maximal satisfaction scores are selected to be included among the filtered training entries.

At step/operation 404, the predictive data analysis computing entity 106 trains the machine learning model based at least in part on the set of filtered training entries. In some embodiments, to train the machine learning model, the predictive data analysis computing entity 106 updates the parameters of the machine learning model to minimize an error measure that is determined based at least in part on each difference measure for a filtered training entry that is determined based at least in part on a difference of an inferred predictive output score for the filtered training entry and a ground-truth label that describes whether the filtered training entry corresponds to the target class. In some embodiments, the predictive data analysis computing entity 106 trains the machine learning model using an optimization-based training routine, such as using a gradient descent training routine (e.g., a batch gradient descent routine, a stochastic gradient descent routine, a gradient descent routine that uses backpropagation, a gradient descent routine that uses backpropagation through time, and/or the like).

Accordingly, various embodiments of the present invention address technical challenges associated with efficiency of training machine learning models given imbalanced training sets by introducing techniques for effective training of machine learning models even given imbalanced training sets. By utilizing the techniques described in relation to various embodiments of the present invention, an imbalanced training set can nevertheless be used to train an effective and reliable machine learning model, a capability that avoids need to perform a large number of training iterations with large training sets to train suitable machine learning models, thus improving resource usage efficiency and operational throughput of predictive data analysis systems that use classification machine learning models that are trained with imbalanced training sets.

For example, various embodiments of the present invention utilize systems, methods, and computer program products that perform predictive data analysis operations by machine learning models that are trained using one or more filtered training entries that are selected from a plurality of candidate training entries in accordance with one or more optimal imbalance adjustment conditions, where the one or more optimal imbalance adjustment conditions that are selected from a plurality of candidate imbalance adjustment conditions in a manner that is configured to maximize a cumulative target score for the one or more optimal imbalance adjustment conditions while a cumulative non-target score for the one or more optimal imbalance adjustment conditions satisfies an upper cumulative non-target score threshold. The noted techniques enable various embodiments of the present invention to effectively train machine learning models even given imbalanced training sets, a capability that avoids need to perform a large number of training iterations with large training sets to train suitable machine learning models, thus improving resource usage efficiency and operational throughput of predictive data analysis systems that use classification machine learning models that are trained with imbalanced training sets.

### Predictive Inference Operations

As described above, various embodiments of the present invention address technical challenges associated with efficiency of training machine learning models given imbalanced training sets by introducing techniques for effective training of machine learning models even given imbalanced training sets. By utilizing the techniques described in relation to various embodiments of the present invention, an imbalanced training set can nevertheless be used to train an effective and reliable machine learning model, a capability that avoids need to perform a large number of training iterations with large training sets to train suitable machine learning models, thus improving resource usage efficiency and operational throughput of predictive data analysis systems that use classification machine learning models that are trained with imbalanced training sets.

For example, various embodiments of the present invention utilize systems, methods, and computer program products that perform predictive data analysis operations by machine learning models that are trained using one or more filtered training entries that are selected from a plurality of candidate training entries in accordance with one or more optimal imbalance adjustment conditions, where the one or more optimal imbalance adjustment conditions that are selected from a plurality of candidate imbalance adjustment conditions in a manner that is configured to maximize a cumulative target score for the one or more optimal imbalance adjustment conditions while a cumulative non-target score for the one or more optimal imbalance adjustment conditions satisfies an upper cumulative non-target score threshold. The noted techniques enable various embodiments of the present invention to effectively train machine learning models even given imbalanced training sets, a capability that avoids need to perform a large number of training iterations with large training sets to train suitable machine learning models, thus improving resource usage efficiency and operational throughput of predictive data analysis systems that use classification machine learning models that are trained with imbalanced training sets.

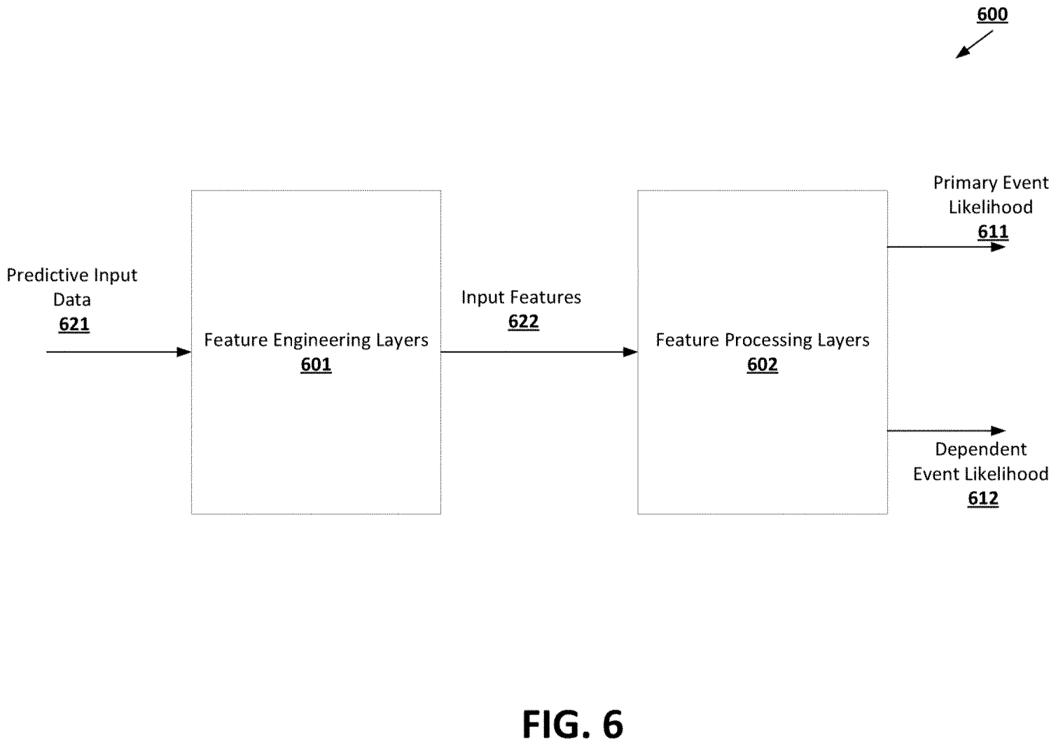

Once generated, the machine learning model can be used to generate a predictive output for a predictive input. An operational example of the machine learning model 600 is depicted in FIG. 6. As depicted in FIG. 6, the machine learning model 600 includes one or more feature engineering layers 601 and one or more feature processing layers 602. The feature engineering layers 601 may be configured to process predictive input data 621 provided by one or more data sources to generate one or more input features 622 that are then processed by the feature processing layers 602 to generate a primary event likelihood 611 and a dependent event likelihood 612.

For example, the feature engineering layers 601 may be configured to generate a first set of input features by generating ICD-10 code embeddings for ICD-10 codes that are associated with a predictive input (e.g., a predictive input that is associated with a particular claim adjudication determination for a particular claim). As another example, the feature engineering layers 601 may be configured to generate a second set of input features by generating Current Procedural Terminology (CPT) code embeddings for CPT codes that are associated with a predictive input (e.g., a predictive input that is associated with a particular claim adjudication determination for a particular claim). As yet another example, the feature engineering layers 601 may be configured to generate a third set of input features by generating ICD-3 code embeddings for ICD-3 codes that are associated with a predictive input (e.g., a predictive input that is associated with a particular claim adjudication determination for a particular claim). As a further example, the feature engineering layers 601 may be configured to generate a fourth set of input features that describe one-hot encodings of a set of categorical features associated with a predictive input. As an additional example, the feature engineering layers 601 may be configured to generate a fifth set of input features that are generated based at least in part on the outputs of processing a set of features associated with a predictive input via one or more fully connected layers. Primary event likelihoods and dependent event likelihoods are described in greater detail below.

In some embodiments, the target class with respect to which the predictions of the machine learning model are generated corresponds to a dependent event whose occurrence is conditioned on the occurrence of a primary event. For example, when the target class corresponds to a class of claim adjudication determinations that are overturned on appeal due to organizational error, then the target class corresponds to a dependent event that describes overturning of an appealed claim adjudication determination due to organizational error, an event whose occurrence is conditioned on the occurrence of a primary event that describes appeal of a claim adjudication determination. In the noted examples, the machine learning model may be configured to generate at least two output values: a primary event likelihood 611 that describes the inferred likelihood that a predictive input is associated with a primary event, and a dependent event likelihood that describes the inferred likelihood that the predictive input is associated with a dependent event.

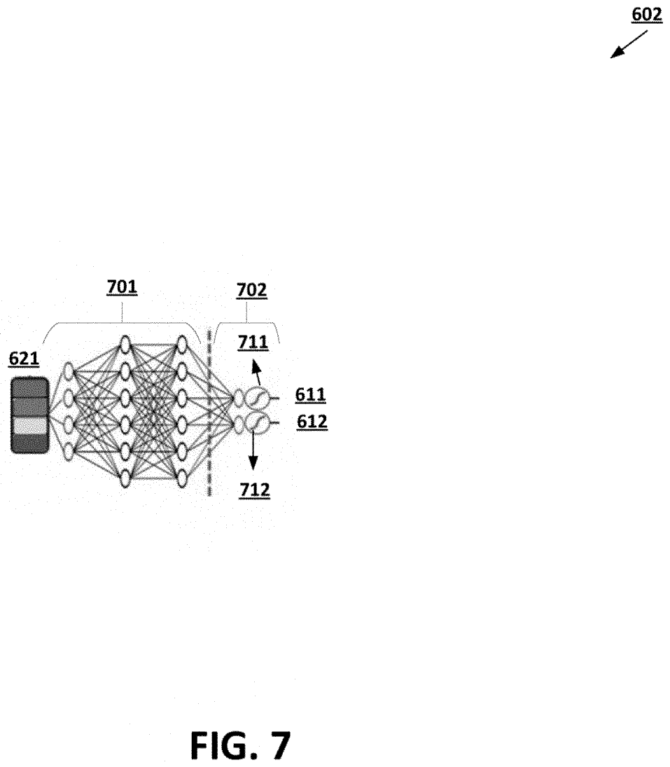

Accordingly, as depicted in FIG. 7, the feature processing layers 602 may include one or more initial feature processing layers 701 and a final feature processing layer 702, where the final feature processing layer 702 includes an identifier node 711 that is configured to determine the primary event likelihood 611 and a differentiator node 712 that is configured to determine the dependent event likelihood 612. For example, the identifier node 711 may be configured to determine an inferred likelihood that a claim adjudication determination is appealed, while the differentiator node 712 may be configured to determine an inferred likelihood that an appealed claim adjudication determination will be overturned due to organizational error.

Once generated, the primary event likelihood and the dependent event likelihood can be combined to generate a predictive output for a predictive input that describes a likelihood that the predictive input is associated with a target class of a plurality of candidate classes, where the target event describes a dependent event that is conditioned upon a primary event. For example, the predictive output may be determined based at least in part on the operations of the below equation:

P_{f}=α*Pᵢ+β*P_{d}+γ*Pᵢ*P_{d} Equation 4

In Equation 4, α is a primary event likelihood adjustment parameter, Pᵢ is the primary event likelihood, β is a dependent event likelihood adjustment parameter, P_{d} is the dependent event likelihood, Pᵢ*P_{d} is a likelihood product factor that is determined based at least in part on a product of the primary event likelihood and the dependent event likelihood, and g is a likelihood product factor adjustment parameter. Accordingly, in Equation 4, α*Pᵢ is the adjusted primary event likelihood that is determined based at least in part on the primary event likelihood and the primary event likelihood adjustment parameter, β*P_{d} is the adjusted dependent event likelihood that is determined based at least in part on the dependent event likelihood and the dependent event likelihood adjustment parameter, and γ*Pᵢ*P_{d} is the adjusted likelihood product factor that is determined based at least in part on the likelihood product factor and the likelihood product factor adjustment parameter.

In some embodiments, the dependent event likelihood adjustment parameter, the primary event likelihood adjustment parameter, and the likelihood product factor adjustment parameter are determined in a manner such that a sum of the dependent event likelihood adjustment parameter, the primary event likelihood adjustment parameter, and the likelihood product factor adjustment parameter has a defined summation value (e.g., in a manner such that α+β+γ=1, where 1 is the defined summation value).

In some embodiments, the dependent event likelihood adjustment parameter, the primary event likelihood adjustment parameter, and the likelihood product factor adjustment parameter are determined in a manner that is configured to optimize a validation error measure, where the validation error measure is determined based at least in part on a per-entry error measure for each validation entry of one or more validation entries, and where the per-entry error measure for a validation entry is determined based at least in part on a difference of an inferred predictive output score for a validation entry and a ground-truth label that describes whether the validation entry corresponds to the target class.

In some embodiments, when the machine learning model comprises an identifier machine learning node and a differentiator machine learning node, training the machine learning model comprises performing a defined number of training iterations, where each training iteration comprises: (i) generating a first training entry batch with training entries that are randomly generated from the set of filtered training entries with ground-truth labels corresponding to occurrence of the primary event (e.g., appeal labels and non-appeal labels) and using the first training entry batch to update parameters of the identifier machine learning node, and (ii) generating a second training entry batch with training entries that are randomly generated from the set of filtered training entries with ground-truth labels corresponding to occurrence of the dependent event (e.g., overturned due to organizational error labels and “other appeal outcome” labels) and using the second training entry batch to update parameters of the differentiator machine learning node.

Once generated, the predictive output can be used to perform one or more prediction-based actions. Examples of prediction-based actions include: (i) generating user interface data for a prediction output user interface that describes, for each predictive input of a set of predictive inputs, the likelihood that the predictive input corresponds to a target class (e.g., for each claim adjudication determination of a set of claim adjudication determinations, the likelihood that the claim adjudication determination is overturned due to organizational error); (ii) automatically performing a secondary review of each predictive input whose predictive output describes that the predictive input is likely to be subject to a dependent event that is associated with a target class (e.g., performing a secondary review of each claim adjudication determination whose predictive output describes that the claim adjudication determination is likely to be overturned on appeal due to organizational error); (iii) automatically changing an adjudication determination of each predictive input whose predictive output describes that the predictive input is likely to be subject to a dependent event that is associated with a target class (e.g., automatically changing an adjudication determination of each claim adjudication determination whose predictive output describes that the claim adjudication determination is likely to be overturned on appeal due to organizational error); (iv) automatically scheduling one or more appointments for each predictive input whose predictive output describes that the predictive input is likely to be subject to a dependent event that is associated with a target class; (v) automatically performing one or more operational load balancing operations setting the working schedules of one or more input review agents based at least in part on a count of each predictive input whose predictive output describes that the predictive input is likely to be subject to a dependent event that is associated with a target class; and/or the like.

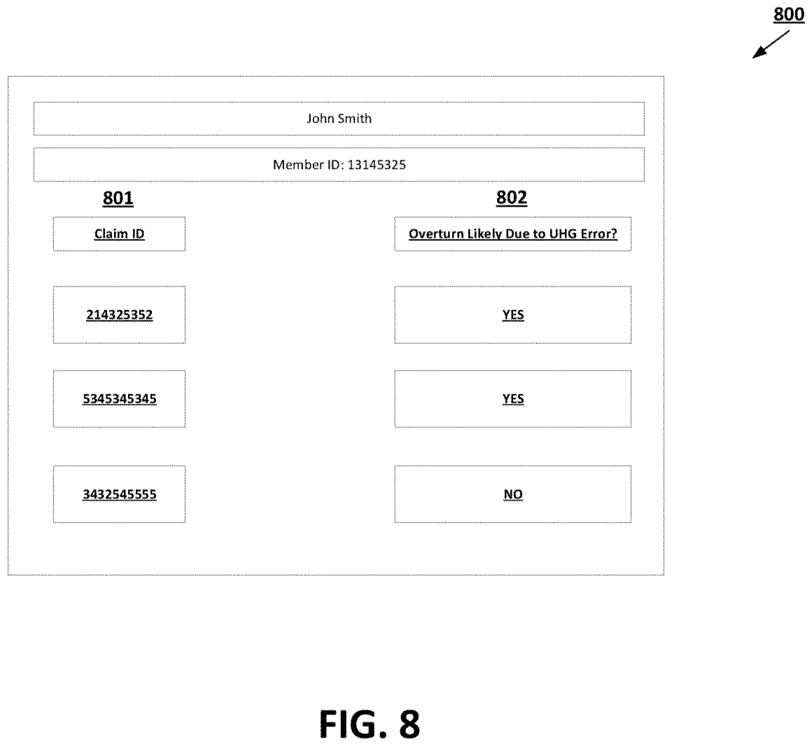

An operational example of a prediction output user interface 800 that can be generated/displayed based at least in part on predictive outputs generated using various embodiments of the present invention is depicted in FIG. 8. As depicted in FIG. 8, the prediction output user interface 800 describes, for each claim identifier 801, a predictive output indication 802 describing whether the claim determination adjudication for the claim is likely to be overturned on appeal due to organizational error (where a YES predictive output indication may be generated if the predictive score for a claim determination adjudication of claim satisfies a threshold value and a NO predictive output indication may be generated otherwise).

### VI. Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for determining a predictive output for a predictive input that describes a likelihood that the predictive input is associated with a target class of a plurality of candidate classes, the computer-implemented method comprising:
determining, using one or more processors and a machine learning model, and based at least in part on the predictive input, the predictive output, wherein: (i) the machine learning model is trained using one or more filtered training entries that are selected from a plurality of candidate training entries in accordance with one or more optimal imbalance adjustment conditions, and (ii) the one or more optimal imbalance adjustment conditions that are selected from a plurality of candidate imbalance adjustment conditions in a manner that is configured to maximize a cumulative target score for the one or more optimal imbalance adjustment conditions while a cumulative non-target score for the one or more optimal imbalance adjustment conditions satisfies an upper cumulative non-target score threshold; and
performing, using the one or more processors, one or more prediction-based actions based at least in part on the predictive output.

2. The computer-implemented method of claim 1, wherein:
each candidate imbalance adjustment condition is associated with a target score and a non-target score,
the cumulative target score is determined based at least in part on each target score for a candidate imbalance adjustment condition that is among the one or more optimal imbalance adjustment conditions, and
the non-cumulative target score is determined based at least in part on each non-target score for a candidate imbalance adjustment condition that is among the one or more optimal imbalance adjustment conditions.

3. The computer-implemented method of claim 2, wherein:
each candidate imbalance adjustment condition is associated with an integer non-target score that is determined by mapping a non-target score for the candidate imbalance adjustment condition to a nearest integer,
the non-cumulative target score is determined based at least in part on each integer non-target score for a candidate imbalance adjustment condition that is among the one or more optimal imbalance adjustment conditions, and
maximizing the cumulative target score while the cumulative non-target score satisfies the upper cumulative non-target score threshold comprises using a Knapsack optimization routine.

4. The computer-implemented method of claim 2, wherein determining the target score for a particular candidate imbalance adjustment condition comprises:
identifying a target subset of the plurality of candidate training entries that are associated with the target class;
for each candidate training entry in the target subset, determining a per-target-entry condition satisfaction ratio based at least in part on: (i) a condition satisfaction indicator that describes whether the candidate training entry satisfies the particular candidate imbalance adjustment condition, and (ii) a cumulative condition satisfaction indicator for the candidate training entry that describes a count of the plurality of candidate imbalance adjustment conditions that are satisfied by the candidate training entry; and
determining the target score based at least in part on each per-target-entry condition satisfaction ratio.

5. The computer-implemented method of claim 2, wherein determining the target score for a particular candidate imbalance adjustment condition comprises:
identifying a non-target subset of the plurality of candidate training entries that are not associated with the target class;
for each candidate training entry in the non-target subset, determining a per-non-target-entry condition satisfaction ratio based at least in part on: (i) a condition satisfaction indicator that describes whether the candidate training entry satisfies the particular candidate imbalance adjustment condition, and (ii) a cumulative condition satisfaction indicator for the candidate training entry that describes a count of the plurality of candidate imbalance adjustment conditions that are satisfied by the candidate training entry; and
determining the target score based at least in part on each per-non-target-entry condition satisfaction ratio.

6. The computer-implemented method of claim 1, wherein:
the target class corresponds to a dependent event that is condition upon occurrence of a primary event,
the machine learning model is configured to generate a dependent event likelihood for the predictive input with respect to the dependent event and a primary event likelihood for the predictive input with respect to the primary event, and
the predictive output is determined based at least in part on the primary event likelihood and the dependent event likelihood.

7. The computer-implemented method of claim 6, wherein generating the predictive output comprises:
determining an adjusted dependent event likelihood based at least in part on the dependent event likelihood and a dependent event likelihood adjustment parameter,
determining an adjusted primary event likelihood based at least in part on the primary event likelihood and a primary event likelihood adjustment parameter,
determining a likelihood product factor based at least in part on the primary event likelihood and the dependent event likelihood,
determining an adjusted likelihood product factor based at least in part on the likelihood product factor and a likelihood product factor adjustment parameter, and
determining the predictive output based at least in part on the adjusted dependent event likelihood, the adjusted primary event likelihood, and the adjusted likelihood product factor.

8. The computer-implemented method of claim 7, wherein the dependent event likelihood adjustment parameter, the primary event likelihood adjustment parameter, and the likelihood product factor adjustment parameter are determined in a manner such that a sum of the dependent event likelihood adjustment parameter, the primary event likelihood adjustment parameter, and the likelihood product factor adjustment parameter has a defined summation value.

9. The computer-implemented method of claim 7, wherein the dependent event likelihood adjustment parameter, the primary event likelihood adjustment parameter, and the likelihood product factor adjustment parameter are determined in a manner that is configured to optimize a validation error measure.

10. The computer-implemented method of claim 9, wherein the validation error measure is determined based at least in part on a per-entry error measure for each validation entry of one or more validation entries.

11. An apparatus for determining a predictive output for a predictive input that describes a likelihood that the predictive input is associated with a target class of a plurality of candidate classes, the apparatus comprising at least one processor and at least one memory including program code, the at least one memory and the program code configured to, with the processor, cause the apparatus to at least:
determine, using a machine learning model, and based at least in part on the predictive input, the predictive output, wherein: (i) the machine learning model is trained using one or more filtered training entries that are selected from a plurality of candidate training entries in accordance with one or more optimal imbalance adjustment conditions, and (ii) the one or more optimal imbalance adjustment conditions that are selected from a plurality of candidate imbalance adjustment conditions in a manner that is configured to maximize a cumulative target score for the one or more optimal imbalance adjustment conditions while a cumulative non-target score for the one or more optimal imbalance adjustment conditions satisfies an upper cumulative non-target score threshold; and
perform one or more prediction-based actions based at least in part on the predictive output.

12. The apparatus of claim 11, wherein:
each candidate imbalance adjustment condition is associated with a target score and a non-target score,
the cumulative target score is determined based at least in part on each target score for a candidate imbalance adjustment condition that is among the one or more optimal imbalance adjustment conditions, and
the non-cumulative target score is determined based at least in part on each non-target score for a candidate imbalance adjustment condition that is among the one or more optimal imbalance adjustment conditions.

13. The apparatus of claim 12, wherein:
each candidate imbalance adjustment condition is associated with an integer non-target score that is determined by mapping a non-target score for the candidate imbalance adjustment condition to a nearest integer,
the non-cumulative target score is determined based at least in part on each integer non-target score for a candidate imbalance adjustment condition that is among the one or more optimal imbalance adjustment conditions, and
maximizing the cumulative target score while the cumulative non-target score satisfies the upper cumulative non-target score threshold comprises using a Knapsack optimization routine.

14. The apparatus of claim 12, wherein determining the target score for a particular candidate imbalance adjustment condition comprises:
identifying a target subset of the plurality of candidate training entries that are associated with the target class;
for each candidate training entry in the target subset, determining a per-target-entry condition satisfaction ratio based at least in part on: (i) a condition satisfaction indicator that describes whether the candidate training entry satisfies the particular candidate imbalance adjustment condition, and (ii) a cumulative condition satisfaction indicator for the candidate training entry that describes a count of the plurality of candidate imbalance adjustment conditions that are satisfied by the candidate training entry; and
determining the target score based at least in part on each per-target-entry condition satisfaction ratio.

15. The apparatus of claim 12, wherein determining the target score for a particular candidate imbalance adjustment condition comprises:
identifying a non-target subset of the plurality of candidate training entries that are not associated with the target class;
for each candidate training entry in the non-target subset, determining a per-non-target-entry condition satisfaction ratio based at least in part on: (i) a condition satisfaction indicator that describes whether the candidate training entry satisfies the particular candidate imbalance adjustment condition, and (ii) a cumulative condition satisfaction indicator for the candidate training entry that describes a count of the plurality of candidate imbalance adjustment conditions that are satisfied by the candidate training entry; and
determining the target score based at least in part on each per-non-target-entry condition satisfaction ratio.

16. The apparatus of claim 11, wherein:
the target class corresponds to a dependent event that is condition upon occurrence of a primary event,
the machine learning model is configured to generate a dependent event likelihood for the predictive input with respect to the dependent event and a primary event likelihood for the predictive input with respect to the primary event, and
the predictive output is determined based at least in part on the primary event likelihood and the dependent event likelihood.

17. The apparatus of claim 16, wherein generating the predictive output comprises:
determining an adjusted dependent event likelihood based at least in part on the dependent event likelihood and a dependent event likelihood adjustment parameter,
determining an adjusted primary event likelihood based at least in part on the primary event likelihood and a primary event likelihood adjustment parameter,
determining a likelihood product factor based at least in part on the primary event likelihood and the dependent event likelihood,
determining an adjusted likelihood product factor based at least in part on the likelihood product factor and a likelihood product factor adjustment parameter, and
determining the predictive output based at least in part on the adjusted dependent event likelihood, the adjusted primary event likelihood, and the adjusted likelihood product factor.

18. An computer program product for determining a predictive output for a predictive input that describes a likelihood that the predictive input is associated with a target class of a plurality of candidate classes, the computer program product comprising at least one non-transitory computer readable storage medium having computer-readable program code portions stored therein, the computer-readable program code portions configured to:
determine, using a machine learning model, and based at least in part on the predictive input, the predictive output, wherein: (i) the machine learning model is trained using one or more filtered training entries that are selected from a plurality of candidate training entries in accordance with one or more optimal imbalance adjustment conditions, and (ii) the one or more optimal imbalance adjustment conditions that are selected from a plurality of candidate imbalance adjustment conditions in a manner that is configured to maximize a cumulative target score for the one or more optimal imbalance adjustment conditions while a cumulative non-target score for the one or more optimal imbalance adjustment conditions satisfies an upper cumulative non-target score threshold; and
perform one or more prediction-based actions based at least in part on the predictive output.

19. The computer program product of claim 18, wherein:
each candidate imbalance adjustment condition is associated with a target score and a non-target score,
the cumulative target score is determined based at least in part on each target score for a candidate imbalance adjustment condition that is among the one or more optimal imbalance adjustment conditions, and
the non-cumulative target score is determined based at least in part on each non-target score for a candidate imbalance adjustment condition that is among the one or more optimal imbalance adjustment conditions.

20. The computer program product of claim 19, wherein:
each candidate imbalance adjustment condition is associated with an integer non-target score that is determined by mapping a non-target score for the candidate imbalance adjustment condition to a nearest integer,
the non-cumulative target score is determined based at least in part on each integer non-target score for a candidate imbalance adjustment condition that is among the one or more optimal imbalance adjustment conditions, and
maximizing the cumulative target score while the cumulative non-target score satisfies the upper cumulative non-target score threshold comprises using a Knapsack optimization routine.
